(19) United States
(12) Patent Application Publication
(10) Pub. No.: US 2008/0010027 A1
(43) Pub. Date: Jan. 10, 2008

(54) Method and apparatus for predicting properties of a chemical mixture

(76) Inventor: David H. Alman, Royal Oak, MI (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/725,810

(22) Filed: Mar. 20, 2007

Related U.S. Application Data
(63) Continuation of application No. 10/911,020, filed on Aug. 3, 2004, now abandoned.

(51) Int. Cl. G06F 15/18; G01N 31/00

(52) U.S. Cl. 702/30; 706/21

(57) ABSTRACT

The present invention relates to a method and apparatus for predicting the non-color properties of a chemical mixture, such as an automotive paint, using an artificial neural network. The neural network includes an input layer having nodes for receiving input data related to the chemical components of the mixture and environmental and process conditions that can affect the properties of the mixture. An output layer having nodes generate output data which predict the properties of the chemical mixture as a result of variation of the input data. A hidden layer having nodes is connected to the nodes in the input and output layers. Weighted connections connect the nodes of the input, hidden and output layers and threshold weights are applied to the hidden and output layer nodes. The connection and threshold weights have values to calculate the relationship between input data and output data. The data to the input layer and the data to the output layer are interrelated through the neural network's nonlinear relationship. When implemented, accurate predictions of the final properties of the mixture can be obtained. The invention is especially useful in relating automotive paint formulation variables (e.g., paint ingredient amounts and application process conditions) to physical properties (e.g., viscosity, sag), appearance (e.g., hiding, gloss, distinctness of image) or other measured properties enabling comparison of formula properties to target values or tolerances without expensive experimental work.

### CROSS-REFERENCE TO RELATED APPLICATIONS

This patent application is a continuation of U.S. patent application Ser. No. 10/911,020, filed Aug. 3, 2004.

### TECHNICAL FIELD

The invention relates to a method and an apparatus for predicting the properties of a chemical mixture, such as a paint, with a high degree of accuracy, using artificial neural networks.

### BACKGROUND OF THE INVENTION

Chemical mixtures, such as automotive paints, are commonly formulated to achieve desirable properties represented by property measurements. A great deal of effort, however, must be spent by laboratory personnel developing these formulas to provide the correct balance of properties.

For example, an automotive paint or coatings formulation consists of a complex mixture of colorants (tints), binders and solvents formulated to provide a balance of properties for color match, appearance, durability, application and film properties. Models are available for quantitative prediction of the color of a mixture but not other properties. Hence, labor-intensive verification experiments are required to measure a coating formulation's properties to assure the values are within acceptable limits.

Such experiments are needed because the relationships between the mixture components and the measured properties are typically complex and unknown. In these cases it would be advantageous to develop predictive models that are capable of relating the mixture components to the properties so that the properties of new mixtures can be estimated. While there have been various attempts to develop predictive models for chemical mixtures, none have gained widespread use in the art.

It would be desirable to provide a method and apparatus capable of predicting the non-color as well as color properties of chemical mixtures, such as coating formulations, so as to enable an operator to determine what input parameters are needed to obtain predetermined properties in the final coating.

Neural networks are one class of predictive models that have been applied to develop empirically-trained models relating process properties to process variables, as shown in Piovoso, M. J. and A. J. Owens, 1991, Sensor data analysis using artificial neural networks, in Arkun and Ray, eds., Chemical Process Control CPC-IV, AlChE, New York, 101-118. Neural network methods are employed herein to develop predictive models of the properties of chemical mixtures.

### SUMMARY OF THE INVENTION

A method and apparatus for predicting the measured properties of a chemical mixture, such as a coating, are provided that employ artificial neural networks.

The method and apparatus are particularly useful for predicting the non-color properties of automotive coatings formulations.

In one embodiment, the neural network includes an input layer having nodes for receiving input data related to the coating formulation (component concentrations). Weighted connections connect the nodes of the input layer and have coefficients for weighting the input data. An output layer having nodes are either directly or indirectly connected to the weighted connections contained in hidden layers. The output layer generates output data that is related to the non-color properties of the coating. The data of the input layer (component concentrations) and the data from the output layer (measured properties) are interrelated through the neural network's nonlinear relationship and can be used, once the neural network is trained, to predict the measured properties of a coating formulation.

Empirical data consisting of historical chemical mixture data and the measured properties of the mixtures is used to train the network weights using a backpropagation method of supervised training. The trained network is then used to predict the measured properties of new chemical mixtures by a feed forward calculation. The invention is useful in describing the relationship between chemical mixture variables and the measured properties of the mixture. The trained network can predict the properties of new chemical mixtures without costly experimental verification.

The chemical mixture neural network can be used for, but not limited to, predicting properties of new mixtures, identifying formula mistakes, or for formula corrections.

Additional advantages and aspects of the present invention will become apparent from the subsequent description and the appended claims, taken in conjunction with the accompanying drawings in which:

### BRIEF DESCRIPTION OF THE DRAWINGS

FIG. 1 is a generalized diagram depicting the structure of the present invention's chemical mixture neural network;

FIG. 2 is a generalized diagram illustrating the calculation process at one node of a chemical mixture network; and

FIG. 3 is a block diagram illustrating the network training and forward prediction processes.

### DETAILED DESCRIPTION OF THE INVENTION

The invention provides a method and apparatus for predicting the properties of a chemical mixture. The invention employs a computer-implemented artificial neural network. The neural network contains at least two layers of processing elements, an input and output layer. The processing elements are interconnected in a predetermined pattern with predetermined connection weights therebetween. The network has been previously trained to simulate the response of the chemical mixture to variation of inputs thereto. When trained, the connection weights between the processing elements contain information regarding the relationship between the components of a chemical mixture (inputs) and the measured properties (outputs) of the mixture, which can be used to predict the final properties of the chemical mixture to variation in the mixture components.

Since the method of the invention is based on historical data of formulation and property values, the prediction of property values using such method typically have an error approaching the error of the empirical data, so that the invention predictions are often just as accurate as verification experiments.

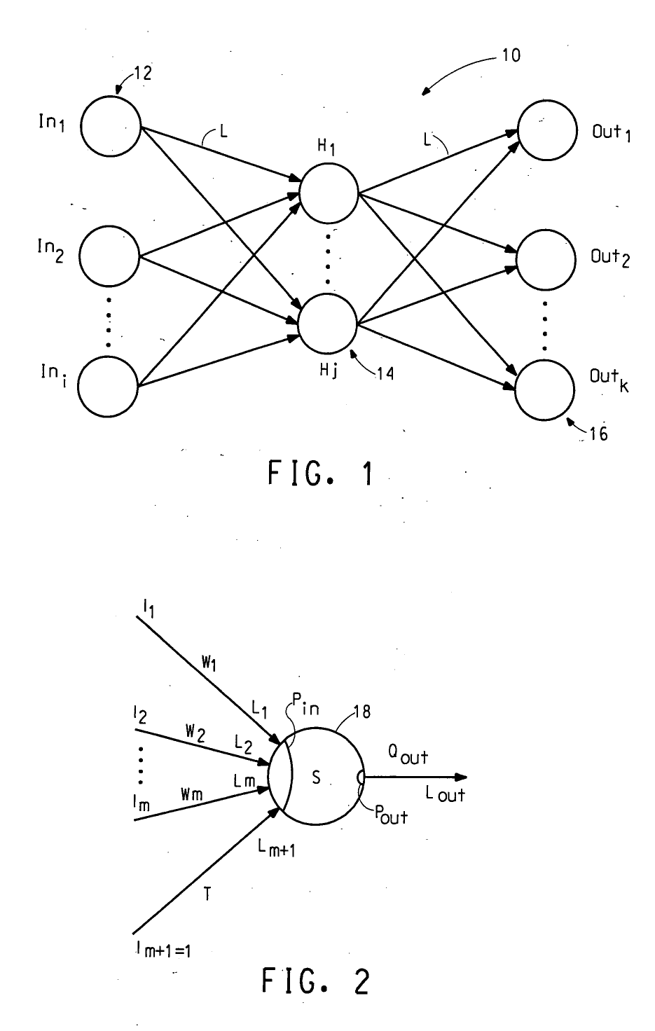

Referring now to the drawings, FIG. 1 shows a chemical mixture neural network generally depicted at 10. The chemical mixture neural network 10 is configured as a backpropagation network which includes three processing layers (or three neuron layers), an input layer 12, a hidden layer 14, and an output layer 16. The network is organized such that the input layer 12 contains a set of at least one to i processing elements called input nodes, the hidden layer 14 has a set of at least one to j processing elements called hidden nodes, and the output layer 16 has a set of at least one to k processing elements called output nodes. The processing elements or nodes are interconnected such that the relationship between chemical mixture component and process condition inputs and measurement property outputs can be simply calculated, when the network is implemented.

In the present invention as shown in FIG. 1, the processing network is organized such that the input layer 12 contains one node (In) for each chemical mixture or process input variable of the model. The input nodes are fully connected to hidden nodes (H) of the hidden layer 14 of the network and the hidden nodes are fully connected to the output nodes (Out) of an output layer 16 of the network. There is one input node for each mixture component or process condition input variable and one output node for each process property measurement output. The connection line arrows (L) indicate the direction of the calculation from input values through the network to the output values. The number of hidden nodes can be varied with increasing number of hidden nodes adding to the network capability to model complexity of the input to output relationship. Each connection line has a connection weight associated with it and each hidden and output node has one additional threshold weight. The network weights are the parameters of the network that allow the network to model the input to output relationship. Networks with multiple hidden layers and networks that are not fully connected are possible alternative network structures but the fully connected three-layer network is sufficient for modeling chemical mixture processes.

FIG. 2 is a generalized representation of the calculation process shown at one node 18, but which is used throughout the network. The nodes are the processing or calculating elements of the network. Each node 18 refers to the calculation process at hidden and output nodes. Each node 18 has an input port Pᵢₙ and an output port Pₒᵤₜ. The node is responsive to one or a plurality of excitation or intensity signal(s) I₁ through Iₘ presented at the input port Pᵢₙ and is operative to produce an activation signal Qₒᵤₜ carried on a line Lₒᵤₜ connected at the output port Pₒᵤₜ. Each of the input intensity values I₁ through Iₘ is connected to the input port Pᵢₙ of the node 18 over a respective line L₁ through Lₘ that has a predetermined respective connection weight W₁ through Wₘ. A threshold weight (T) without any input connection provides a threshold level for the node input. This is equivalent to one additional input connection line Lₘ₊₁ to the node with a constant excitation signal or intensity Iₘ₊₁ of 1. The activation signal Qₒᵤₜ that is produced on line Lₒᵤₜ at the output port Pₒᵤₜ of the node is a function of the input signal Qᵢₙ applied at the input port Pᵢₙ. The input signal Qᵢₙ is the summation, over all of the input lines to the node, of the product of the intensity of a given excitation signal I and the connection weight W of the line L carrying the signal to the node plus the threshold weight as shown in Equation 1.

$${Q}_{in} = T + {\sum }_{z = 1}^{m} {w}_{z} {I}_{z} \qquad ( 1 )$$

The node output (Qₒᵤₜ) is computed by a non-linear squashing function (S) that limits Qₒᵤₜ to a finite range for any value of Qᵢₙ. The typical squashing function is the logistic function as shown in equation 2 but any non-linear monotonic increasing function could be used.
S=(1+exp(−Qᵢₙ))⁻¹ (2)

The node output then is the squashed non-linear response to the linear node inputs as shown in equation 3 and as carried on one or more lines (Lₒᵤₜ) to nodes in the next network layer.
Qₒᵤₜ=S(Qᵢₙ) (3)

The node outputs are then the intensities of the inputs to the nodes in the next layer of the network. The node calculation is carried out at all hidden and output layer nodes but not at input layer nodes. The input layer has a single input intensity value and no squashing function. The input layer nodes simply represent the input data intensity values. The Qₒᵤₜ values of the output layer are the network estimates of the property values.

It is usual to scale all input and output values of the network to a convenient range such as 0 to 1. The unscaled input and output data values are transformed to fall within this range. The transformation can be any monotonic function with output in the range 0 to 1. Typically the scaling operation is a linear transform but logarithmic, exponential or other monotonic transforms of a single variable can also be used.

The usual practice is to use the same scaling operation for inputs or outputs with common data characteristics. For example all mixture components have intensities between 0 and 1 and thus all can use the same input scaling transform. Conversely input or output values with dissimilar number scales (e.g. mixture components (0 to 1), process temperature (60 F to 90 F)) will typically have different scaling transformations.

To build such a neural network that can be used to predict the properties of a chemical mixture, the method of the invention comprises four phases: data collection, network structure, training and forward prediction.

Data collection provides empirical information to train the network. Chemical mixture component amounts and mixture property measurements are obtained from process history or calibration experiments. Additional process variables such as environmental conditions or chemical mixture application conditions may influence the measured property values. Data for these independent variables are collected for use in modeling the relationships between process inputs and outputs.

A network structure is constructed with input nodes for each process variable (mixture components and process conditions), one or more hidden nodes and outputs nodes for each process property measurement. The nodes are fully connected by weight connections between input and hidden and between hidden and output nodes. Additional threshold weights are applied to the hidden and output nodes. Each network node represents a simple calculation of the weighted sum of inputs from prior nodes and a non-linear output function. The combined calculation of the network nodes relates the process inputs to the outputs. Separate networks can be developed for each property measurement or groups of properties can be included in a single network.

Training estimates network weights that allow the network to calculate output values close to the measured output values. A supervised training method is used in which the process output data is used to direct the training of the network weights. The network weights are initialized with small random values or with the weights of a prior partially trained network. The process data inputs are applied to the network and the output values are calculated for each training sample. The network output values are compared to the measured output values. A backpropagation algorithm is applied to correct the weight values in directions that reduce the error between measured and calculated outputs. The specific type of backpropagation algorithm used is a stiff ordinary-differential-equation algorithm as described in U.S. Pat. No. 5,046,020 issued to David L. Filkin, Distributed Parallel Processing Network Wherein the Connection Weights are Generated Using Stiff Differential Equations, and in Owens, A. J. and D. L. Filkin, 1989, Efficient training of the back propagation network by solving a system of stiff ordinary differential equations, International Joint Conference on Neural Networks, Washington, D.C., 2, 381-386, which disclosures are hereby incorporated by reference. The process is iterated until no further reduction in error can be made. A cross-validation method is employed to split the data into training and testing data sets. The training data set is used in the backpropagation training of the network weights. The testing data set is used to verify that the trained network generalizes to make good predictions on independent chemical mixtures. The best network weight set is taken as the one that best predicts the outputs of the test data set. Similarly varying the number of network hidden nodes and determining the network that performs best with the test data optimizes the number of hidden nodes.

Forward prediction uses the trained network to calculate estimates of process outputs for new chemical mixtures. A new set of mixture and process values is input to the trained network. A feed forward calculation through the network is made to predict the output property values. The predicted measurements can be compared to property target values or tolerances. If the predicted property values are unacceptable, varying the process-input values can make a correction.

When implementing the network, the mixture components and optionally process conditions are considered the inputs to the chemical mixture model and the measured properties are considered the outputs of the chemical mixture model. Variation in the measured properties is related to variation in the mixture components. That is the mixture components are the independent variables of the process and the measured properties are dependent variables of the process.

Mixture components are expressed as fractional concentrations of the total amount of the mixture. In general the property of a mixture depends on the component fractional concentrations rather than the total amount of the mixture. For example a 50:50 volume mixture of water and antifreeze has a freezing temperature of −30 F and the freezing temperature does not depend on whether the mixture sample amount is 1 ml or 1 l. Mixture formulas can be expressed in weight, volume or other quantity units. The fractional concentration is simply the quantity of a component in the mixture divided by the total quantity of the mixture. The sum of the fractional concentrations will be unity. Fractional concentrations are continuous variables in the range 0 to 1.

Properties of the mixture can be any measurable characteristic. The characteristic can be a continuous, ordinal or nominal measurement. For example a formulated coating could have a measurement of the viscosity of the liquid mixture on a continuous scale. Another measurement could be the measurement of orange peel of the applied coating film on a 10 category ordinal scale from 1 (very unsmooth) to 10 (very smooth). An example of a nominal measurement could be the coded categories of pass or fail for observation of some defect.

Many times the measured properties of mixtures depend on process variables in addition to the mixture components. For example environmental variables may influence a property measurement. In the coating example above the temperature of the mixture during measurement can influence the measurement of viscosity. Inclusion of temperature as a process input variable could improve the model performance. Application variables can also influence the property measurements and can be included in the process model as inputs. A mixture might be processed on equipment A, B or C. Three binary variables could be used to code for the equipment nominal variable as shown in table 1.

TABLE 1
Example of the use of binary variables to code
for three levels of a nominal variable

| Variable | Equipment A | Equipment B | Equipment C |
|---|---|---|---|
| X1 | 1 | 0 | 0 |
| X2 | 0 | 1 | 0 |
| X3 | 0 | 0 | 1 |

Thus the process model has one continuous input for each chemical mixture component and optionally can have additional continuous, ordinal or nominal non-mixture process inputs. In a similar fashion the process model can have one or more measured outputs and the outputs can be continuous, ordinal or nominal variables.

A single example of a set of process input and output values is called an exemplar. A collection of input and output data values is required to develop the process model. These exemplars can be obtained from either a process calibration experiment or process history.

The process data should cover the useful range of each of the process inputs. For example if mixture component A is used in the range 0 to 0.1 and component B in the range 0.3 to 0.7 then the process data should include samples with several levels of A and B within these constrained ranges. Since the input to output relationship is frequently complex, non-linear and interactive the samples should cover the useful range in combinations with multiple levels of other process inputs. A calibration experiment is designed to sample the mixture design space and include varying levels of the mixture components. Some of these samples may be pure mixtures or simple binary or ternary blends. It is useful to also include complex mixtures that simulate the usual multi-component mixtures of the process.

Alternatively process history data can be collected from the routine operation of the process. Sometimes the routine process may not sample the full potential range of a process variable or there may be few exemplars for a particular mixture component. Combination of process history and calibration data can overcome this problem. The calibration data assures that each component is adequately sampled over its design range while the history data provides samples in frequently used regions of the mixture space.

The process data is used to train the chemical mixture network. Cross-validation splits the process data into training and testing data sets. Typically 80% of the data is used to train the network and 20% is reserved for estimating the error of the network with data that is independent of the training. The testing data set allows the network developer to verify that the trained network relationship between process inputs and outputs will generalize to new exemplars.

When the network is trained, it provides a model of the relationship between chemical mixture component and process condition inputs and measurement property outputs. When implemented, as shown in FIGS. 1 and 2, the network can simply calculate measured properties based on variation of inputs to a high degree of accuracy.

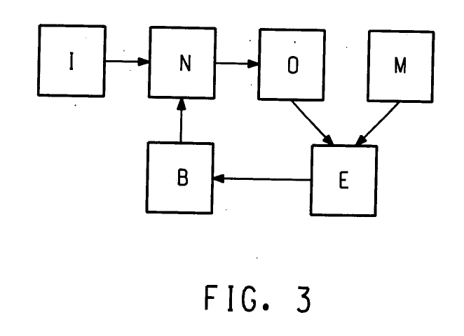

FIG. 3 is a block diagram depicting the process for supervised training of the chemical mixture neural network. Training exemplars are introduced to the input block (I) and fed forward to the network block (N) that computes the output estimates in the output block (O). Error block (E) contains the observed differences between the output estimates (O) and the measured property values (M). Supervised training refers to the use of known output measurement values to guide the training of the network weights to minimize the differences between the output estimates and the output measurements. Training uses a backpropagation training algorithm. A network structure with one or more hidden nodes is assumed. The network weights are initialized by one of two methods. In the first method all of the network weights are given small random values. In a second method a prior trained network with h hidden nodes is used to initialize a network with more than h hidden weights. The connection and threshold weights associated with the added hidden nodes are initialized with small random values and the remaining weights are initialized by adopting the weights of the prior network. Each training exemplar is applied to the network and the output estimates and differences are obtained. The backpropagation algorithm (B) adjusts the network weights in small steps in directions that reduce the differences. The backpropagation algorithm iterates until a local minimum of the least squared error of the differences is obtained. The rms (root mean square) error of the differences is found and represents the estimated error of the network for the training exemplars.

The trained network is verified by cross-validation. The test exemplars are input to the network obtaining output estimates that are compared to the known output values to determine differences. The rms error of the test data set is compared to the rms error of the training data set. The best of a set of models at varying number of training iterations is taken as the network with minimum test error. This is the network that best generalizes the input to output relationship to new independent exemplars. Similarly, networks at varying number of hidden units are compared and the network with minimum test rms error is taken as the best network.

The trained chemical mixture network is then employed to make predictions of the property measurements of new exemplars by forward prediction. New sets of input values are introduced to the network (I), fed forward through the network calculation (N) to predict estimates of the property values (O). Estimated property values can be compared to target values or tolerance limits to determine whether the mixture is suitable for its intended purpose. The sensitivity of the output estimates to variation of the input values in the vicinity of the input mixture can be determined and used to guide interactive or automated adjustment of the input values to yield acceptable property estimates.

The following examples are given to illustrate the invention and should not be interpreted as limiting in any way.

In particular, these examples illustrate the invention in the context of predicting the non-color properties of automotive coating formulations, for example, physical properties (viscosity, sag) and appearance (hiding, gloss, distinctness of image) when input variables (paint ingredient amounts, application process conditions) are varied. One skilled in the art would understand that the method of the present invention also is useful for predicting the properties of other kinds of chemical mixtures, whether solids or liquids, including, but not limited to, other types of paints and coatings, inks including ink jet inks, alcohols, diesel fuel, oil, plastics, polymer blends, films, and the like.

### EXAMPLE 1

Neural networks were developed to predict the relationship between coatings formulations and substrate hiding in automotive collision repair coatings systems. Four collision repair coatings systems coded A, B, C, D were used. All four systems are intermix systems of single pigment tint and binder components that can be combined to make a wide variety of colors to match an automotive color being repaired. Systems A and C are used for repair of solid automotive colors and systems B and D are used to repair automotive colors containing metallic or pearlescent flakes. We denote the latter type of colors as effect colors. The coating mixture to be used for a repair is defined by a formula indicating the mass amounts of the components to make a customary volume of the liquid coating. For example the formula component amounts in grams to make a gallon volume could be used. The property to be predicted is the film thickness required to eliminate the visual contrast of the color over black and white substrates. We call this property black and white hiding and measure the property by a method described under Test Methods. Hiding is measured as a film thickness and in our case we measure thickness in mil units.

Process formula and hiding data were obtained for the four coatings systems. For systems A and B new calibration samples were prepared including ladders of each tint in blends with either a white tint for solid colors or an aluminum flake tint for effect colors. In addition historical process formulas were prepared with new measurements of hiding. Some formulas were made at two levels of the ratio of pigment solid mass to binder solid mass (called the pigment to binder ratio, P/B) to provide variation in the binder level for similar color formulas. For systems C and D the formulas and hiding data were taken from historical process records.

The tint and binder component formulas were normalized so that the component mass concentrations sum to 1. All component concentrations used a common linear scaling to provide the inputs to the network. Measured hiding was logarithmically scaled to form the output of the network. Network hiding estimates are transformed to the natural units for comparison to the measured hiding values.

Networks were trained by backpropagation at varying number of hidden units and the best network determined by the cross-validation method. Table 2 summarizes the results for the chemical mixture prediction networks for the four coatings systems. The network structure (I-H-O) gives the number of nodes in the input, hidden and output layers of the network. The process hiding data is summarized by count, data mean, data minimum and data maximum. The network prediction performance is shown by the standard deviation of the residuals between the estimated and measured hiding values.

TABLE 2
Summary of chemical mixture prediction
networks for four coatings systems

| | | | | | | Residual |
|---|---|---|---|---|---|---|
| | | | Data | Data | Data | standard |
| | Network | Data | Mean | Min | Max | deviation |
| System | (I-H-O) | count | (mil) | (mil) | (mil) | (mil) |
| A | 43-3-1 | 527 | 1.32 | 0.14 | 7.21 | 0.21 |
| B | 64-2-1 | 723 | 0.79 | 0.11 | 8.27 | 0.24 |
| C | 41-2-1 | 1925 | 1.24 | 0.08 | 6.00 | 0.28 |
| D | 69-3-1 | 11232 | 0.65 | 0.12 | 5.20 | 0.14 |

Multiple linear regression (MLR) models were developed for hiding as a function of a mixture model of the components for coatings systems A and B. The residual standard deviations for the network and MLR models were 0.21 and 0.49 respectively for system A and 0.24 and 0.32 respectively for coatings system B. In both cases the chemical mixture prediction network has lower residual error than a MLR model with the same mixture component inputs.

Coatings mixture networks for hiding prediction for systems A, B, C, and D are implemented in proprietary software for automotive color matching to aid the technician in adjusting binder level to meet process goals for hiding. The software provides a hiding estimate by forward prediction for any mixture of the coatings system components.

### EXAMPLE 2

A collection of about 3300 solid colors was developed in a coatings intermix system for the heavy-duty truck fleet market. There was desire to provide property estimates for the color formulas in this special collection. The properties of interest included black and white hiding, viscosity, appearance, orange peel and sag. Measurements of these properties are described under Test Methods.

The formulas and property measurement data were taken from the first 1213 color formula developments. These data include a small number of calibration samples at or near the masstone formula for single tints with appropriate balancing binder additions. The remainder were actual process formulas. Property measurements for 100 color formulas were repeated to estimate the replication error of the property measurements. At the time the data was extracted some of the property data was incomplete so that between 1088 and 1200 exemplars were available for the various property measurements.

Fourteen single pigment tints and one binder were the components of the mixtures. The weight formulas were normalized so that the sum of the components was 1 and the components are in fractional mass concentration units. The appearance network had an additional process variable for coating film thickness in mil. The mixture components all used the same linear input transform. The film thickness input had a separate linear input transform.

Correlated property measurements were grouped within a network. For example, a viscosity prediction network had outputs for unactivated viscosity, activated viscosity at time 0 min., activated viscosity at 30 min. and activated viscosity at 60 min. In another example an appearance network had outputs for 20-degree gloss, 60-degree gloss and distinctness of image. The remaining properties of hiding, orange peel and sag each had a separate network. All outputs were linearly scaled.

Chemical mixture prediction networks were trained by backpropagation for each set of properties at varying number of hidden units with the best network selected by the cross-validation method. Table 3 summarizes the results. The residual standard deviation between network property estimates and measurements is comparable to the standard deviation of differences between replicate property measurements. The network predictions are as accurate as property measurements.

TABLE 3
Summary of chemical mixture prediction networks for an intermix coatings system

| | | | | | | | Residual | Replicate |
|---|---|---|---|---|---|---|---|---|
| | | Network | Data | Data | | | standard | standard |
| Property Set | Properties | (I-H-O) | count | Mean | Data Min | Data Max | deviation | deviation |
| Hiding | | 15-3-1 | 1103 | 1.01 | 0.4 | 5.5 | 0.19 | 0.20 |
| Viscosity | unactivated | 15-4-4 | 1088 | 11.2 | 8.2 | 27.1 | 0.90 | 0.75 |
| | activated 0 | | | 10.5 | 7.9 | 16 | 0.68 | 0.72 |
| | activated 30 | | | 11.9 | 8.7 | 17.5 | 0.82 | 0.89 |
| | activated 60 | | | 13.5 | 9.9 | 20.1 | 1.08 | 1.12 |
| Appearance | 20 gloss | 16-4-3 | 1101 | 88.7 | 44 | 95 | 3.33 | 3.63 |
| | 60 gloss | | | 95 | 83 | 99 | 1.25 | 1.86 |
| | DOI | | | 81.7 | 15 | 96 | 7.55 | 11.43 |
| Orange peel | | 15-4-1 | 1103 | 6.6 | 2 | 8 | 0.58 | 0.80 |
| Sag | | 15-2-1 | 1200 | 2.9 | 1.6 | 9.2 | 0.51 | 0.49 |

Forward prediction using the chemical mixture property prediction networks was employed to estimate the properties of 2200 additional color formulas in the special solid color collection.

### TEST METHODS USED IN THE EXAMPLES

The following test methods were used for generating data reported in the examples above:

Hiding Measurement

Visual black and white hiding of an automotive coating is measured by determining the visual threshold for contrast of the coating over black and white substrates. A black and white contrast test strip (Leneta black & white spray monitors, form M71 or equivalent) is adhered to a 4×12 inch aluminum or steel substrate panel. The coating is spray applied to the panel with film thickness variation in a continuous gradient from thin at one end of the panel to thick at the other end so that the hiding contrast threshold appears in the center third of the panel. For example, if the hiding contrast threshold occurs at 1.5 mil then the wedge is prepared so that the film thickness varies from about 1 mil at the thin end to about 2 mil at the thick end. The test sample is called a hiding wedge. The hiding wedge is viewed by a technician under standardized lighting conditions. The technician determines the position on the hiding wedge where the visual contrast between the coating color over black and over white just disappears. This is the visual hiding contrast threshold. The thickness of the coating over the steel or aluminum substrates at the threshold position is measured and reported as the black and white hiding value. Hiding values are usually reported in mil or micrometer units.

Sag Measurement

Sag for an automotive coating is the film thickness at which a vertically applied coating appears to sag or drip down the vertical surface. The test coating is vertically applied with varying film thickness along one dimension of a sag test panel. The sag test panel is a 10 by 10 inch steel substrate with electrocoat primer and with six metal rivet heads spaced along the upper region of the panel. Sag is marked in the area below rivet heads where a teardrop forms or where a ½ inch windowpane is measured at the top of the panel (whichever occurs 1^{st}). The sag sample is spray applied with the rivets in a vertical position on the left or right side of the panel and is baked vertically with the rivets aligned horizontally at the top of the panel according to the product specification. The technician visually observes the sag test sample and determines the position where sag first occurs. The coating film thickness is measured at the sag position and the sag value is reported as a film thickness in mils or micrometers.

Viscosity Measurement

The viscosity of a liquid paint sample is determined by measuring the time required for a known volume of the paint to flow through a hole of known diameter in a viscosity cup. The method is equivalent to ASTM-D-1084, Method D. A Zahn viscosity cup supplied by Paul N. Gardner, Pompano Beach, Fla. 33060 or equivalent is used. The cup consists of a 44+−0.5 ml stainless steel cup with wire handles and a fixed diameter efflux hole. The paint sample fills the fixed volume of the cup. A stopwatch or other timing device is employed to measure the time elapsed between the start of efflux and the first break in the stream exiting the efflux hole. Viscosity is reported in seconds of efflux.

In reactive two-component paint systems it is useful to monitor the increase in viscosity after the paint is activated with a reaction initiator. The viscosity of the unactivated paint, activated paint immediately after activation, activated paint after 30 minutes and activated paint after 60 minutes are measured to assure that viscosity remains within acceptable ranges.

Appearance Measurements

A coating sample is applied and baked according to the product specification to prepare a test sample for appearance measurements. Orange peel is determined by visual comparison of the test sample surface texture to a series of orange peel standards varying in 10 steps from very rough texture (scale 1) to very smooth texture (scale 10). The orange peel reference standards are supplied by ACT Laboratories Inc., Hillsdale, M149242 as product Apr14941 at. Gloss is measured by a process equivalent to ASTM D523-89 Standard Test Method for Specular Gloss. A HunterLab ProGloss PG-3 gloss meter or equivalent measures the test sample gloss at 20 and 60 degree angles of specular reflection. Distinctness of image is measured by a process equivalent to ASTM E430-97 Standard Test Method for Measurement of Gloss of High-Gloss Surfaces by Goniophotometry using a HunterLab Dorigon II distinctness of image meter.

Various modifications, alterations, additions or substitutions of the methods and apparatus of this invention will be apparent to those skilled in the art without departing from the spirit and scope of this invention. This invention is not limited by the illustrative embodiments set forth herein, but rather is defined by the following claims.

What is claimed is:

1. A method for predicting non-color properties of a coating formulation, comprising:
a) collecting history and/or calibration data made up of coating formulation variables including coating formulation ingredient amounts and optionally other environmental and application process variables and the corresponding measured properties of these mixtures;
b) developing a neural network having the capability of associating the contribution of the coating formulation variables to the measured properties of the mixtures;
c) supervised training of the neural network using history and/or calibration data so that the network predicts the relationship between the coating formulation variables and the measured properties;
d) employing the neural network to make forward predictions of gloss, distinctness of image, orange peel, viscosity, or sag measurements of said coating formulations.

2. The method according to claim 1, wherein after step (d) the predicted non-color properties can be compared to property performance targets, so that coating formulation adjustments can be made to meet property performance targets.

3. The method of according to claim 1, wherein the neural network includes an input layer having a plurality of input nodes that are associated with each mixture ingredient, environmental and application process variable, at least one hidden layer having hidden nodes, an output layer having one or more output nodes representing output properties of the mixture, weighted connections between the input nodes of the input layer, the hidden nodes of the hidden layers and the output nodes of the output layer, and threshold weights on all hidden and output nodes, wherein the weighted connections and threshold weights determine the contribution of the mixture ingredients and optionally the other environmental and process variables to the measured properties.

4. The method according to claim 1, wherein the historical and/or calibration data further includes either or both environmental variables and application process variables.

5. The method according to claim 1 wherein the measured non-color properties of the coating formulation include properties of the wet coating and/or properties of coatings formed therefrom.

6. A system for carrying out the method of claim 1, said system comprising:
a) an input device for entering a coating formulation recipe that contains two or more ingredients;
b) a neural network previously trained to predict the measured property response of the coating formulation to variation in mixture ingredient amounts and optionally environmental and process variables;
c) an output device that displays the predicted gloss, distinctness of image, orange peel, viscosity, or sag properties of the coating formulation entered into the network using the input.

7. The system according to claim 6, wherein after the output device displays the predicted non-color properties, the predicted properties can be compared to property performance targets, so that coating formulation adjustments can be made to meet property performance targets.

8. The system according to claim 6, wherein the neural network includes an input layer having a plurality of input nodes that are associated with each mixture ingredient, environmental and application process variable, at least one hidden layer having hidden nodes, an output layer having one or more output nodes representing output non-color properties of the mixture, weighted connections between the input nodes of the input layer, the hidden nodes of the hidden layers and the output nodes of the output layer, and threshold weights on all hidden and output nodes, wherein the weighted connections and threshold weights determine the contribution of the mixture ingredients to the measured non-color properties.

9. The system according to claim 6, wherein the neural network is trained to predict the measured property response of the coating formulation to variation in mixture ingredient amounts and either or both environmental and application process variables.

10. A method for predicting a non-color property of a coating formulation, comprising:
a) collecting history and/or calibration data made up of coating formulation variables including coating formulation ingredient amounts and optionally other environmental and application process variables and the corresponding measured properties of these mixtures;
b) developing a neural network having the capability of associating the contribution of the coating formulation variables to the measured properties of the mixtures;
c) supervised training of the neural network using history and/or calibration data so that the network predicts the relationship between the coating formulation variables and the measured properties;
d) employing the neural network to make a forward prediction of the property of hiding of said coating formulation.

11. A system for carrying out the method of claim 10, said system comprising:
a) an input device for entering a coating formulation recipe that contains two or more ingredients;
b) a neural network previously trained to predict the measured property response of the coating formulation to variation in mixture ingredient amounts and optionally environmental and process variables;
c) an output device that displays predicted hiding property of the coating formulation entered into the network using the input.
